(19) United States
(12) Patent Application Publication
(10) Pub. No.: US 2017/0101298 A1
(43) Pub. Date: Apr. 13, 2017

(54) POST-MIX BEVERAGE DISPENSER

(71) Applicant: O.D.L. S.R.L., Lierna (IT)

(72) Inventor: Massimiliano Renzi, Lierna (IT)

(73) Assignee: O.D.L. S.R.L., Lierna (IT)

(21) Appl. No.: 15/313,827

(22) PCT Filed: May 27, 2015
(86) PCT No.: PCT/IB2015/053969

§ 371 Date: Nov. 23, 2016

(30) Foreign Application Priority Data
May 27, 2014 (IT) MI2014A000973

(51) Int. Cl. B67D 1/00; B67D 1/08; B67D 1/12

(52) U.S. Cl. CPC B67D 1/0032; B67D 1/1218; B67D 1/0855; B67D 1/1279; B67D 1/0043

(57) ABSTRACT

A device according to the present invention is of the post-mix type for dispensing beverages on a user's premises and mixing at least a first component (10) and a second component (20) to obtain a beverage. The device comprises a flow measuring means (100) configured to produce measurement information relating to the flow of the first component; a flow rate adjustment means (250) configured to vary the flow rate of the second component; a control means (300) configured to receive the measurement information (32) and to control the flow rate adjustment means (250) on the basis of the measurement information and a predetermined parameter; and a mixing means (400) disposed downstream of the flow rate adjustment means and configured to mix the first (12) and second (22) components.

### FIELD OF THE INVENTION

The present invention relates to devices, methods and a computer program for post-mix type beverage dispensing.

### BACKGROUND OF THE INVENTION

Systems for dispensing carbonated or non-carbonated beverages of a post-mix type, i.e. in which two or more components, normally still or carbonated water and syrup are mixed so as to obtain the final beverage directly from the outlet of the dispensing tap, are well known devices.

The solutions adopted to date include regulation systems such as a simple adjustment screw, as well as what are called flow-control systems, typically based on mechanically adjustable solutions. One of the biggest problems of these devices is that of accurately dosing the syrup irrespective, for example, of the temperature of the syrup or the pressure at which water is available from the mains water supply. These variables, in fact, influence the final ratio between water and syrup and can alter it if use is made of a system like the known ones.

In the prior art, regulating the ratio between the two components is difficult because, for example, once the flow rate of one component is fixed, the flow rate of the other must be adjusted, an operation that is normally performed by means of a refractometer for measuring the sugar content of the beverage. If one moreover wishes to vary the outflow rate of the beverage, the mixer will need to be recalibrated each time. Similarly, different batches of syrup require recalibration, even if the volumetric ratio between water and syrup remains the same.

### SUMMARY OF THE INVENTION

The object of the present invention is to remedy the problems tied to the known techniques of dispensing beverages of the post-mix type.

According to a first aspect of the invention, there is provided a post-mix type device for dispensing beverages at a user and mixing at least a first component and a second component. The device comprises a measuring means, an adjustment means, a control means and a mixing means.

The flow measuring means is configured to produce measurement information relating to the flow of the first component.

The flow rate adjustment means is configured to vary the flow rate of the second component.

The control means is configured to receive the measurement information and to control the flow rate adjustment means on the basis of the measurement information and a predetermined parameter.

The mixing means is disposed downstream of the flow rate adjustment means and is configured to mix the first and second components.

According to a second aspect of the invention, there is provided a method for dispensing beverages on the user's premises and post-mix type mixing of at least a first component and a second component, the method comprising the steps of:
producing measurement information relating to the flow of the first component;
varying the flow rate of the second component on the basis of the measurement information and a predetermined parameter;
mixing the first and second components.

According to a third aspect of the invention, there is provided a computer program comprising instructions suitable for executing, when the program is run on a computer, the steps of the method, for example as summarised above with reference to the first aspect.

According to a fourth aspect of the invention, there is provided a post-mix type device for dispensing beverages at a user and mixing at least a first component (10) and a second component (20), the device comprising a flow measuring means, a flow rate adjustment means, a pushing means, a control means and a mixing means. In particular, the flow measuring means is configured to produce measurement information relating to the flow of the first component. The flow rate adjustment means is configured to vary the flow rate of the first component. The pushing means is configured to generate a known flow of the second component, according to this fourth aspect. The control means is configured to receive the measurement information and to control the flow rate adjustment means on the basis of the measurement information and a predetermined parameter. The mixing means is disposed downstream of the flow rate adjustment means and configured to mix the first and second components.

### LIST OF FIGURES

FIG. 1 is a block diagram showing a first embodiment of the invention in which there is a means for measuring the flow of the first component and a means for adjusting the flow rate of the second component.

FIG. 2 is a block diagram schematically illustrating a method for mixing the components of a beverage according to a second embodiment of the present invention.

FIG. 3 is a block diagram showing a third embodiment of the invention in which there are two means for measuring flow (of the first and second components) and a means for adjusting the flow rate of the second component.

FIG. 4 is a block diagram showing a fourth embodiment of the invention in which there are two means for measuring flow (of the first and second components) and two means for adjusting the flow rate (of the first and second components).

FIG. 5 is a diagram showing a fifth embodiment of the post-mix mixing system of the present invention.

FIG. 6 is a drawing with a sectional view of a flow rate adjustment means.

FIG. 7 is a drawing with a sectional view of a flow rate adjustment means.

FIG. 8 is a block diagram showing a further embodiment of the invention in which there is a means for measuring flow and a means for adjusting the flow rate of the first component, whereas the second component is delivered in a constant flow.

FIG. 9 is a block diagram showing a further embodiment of a multi-beverage device of the post-mix type.

### DETAILED DESCRIPTION

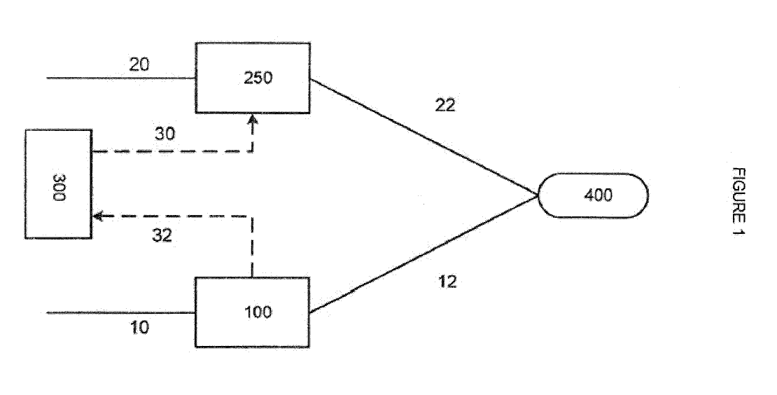

A first embodiment of the present invention will now be described with reference to FIG. 1, which illustrates a post-mix type device for dispensing beverages at a user and mixing at least a first component and a second component.

Post-mix type mixing means that both the mixing of the components (for example, but not necessarily, still or carbonated water and syrup) necessary for obtaining the beverage and the dispensing of the beverage obtained take place on the same site. This site is typically the premises of the user, that is, of the subject for whom the beverage is dispensed. Therefore, in systems of the post-mix type, the beverage is not delivered to the dispensing site in its final form, for example after have been obtained in sophisticated industrial production plants and then transported to the site; the beverage is instead obtained on site by combining two or more of its ingredients at the time of serving. The expression “at the time of dispensing” is not strictly to be understand as meaning “simultaneously with dispensing”; in fact, a certain interval of time might elapse between the combining of the components and the actual dispensing into a glass, for example the time necessary for the beverage to travel through sections of tubing, or technical times necessary for the operation of the post-mix mixing machine. For this purpose, the insertion of possible constructive parts between on-site mixing and dispensing (for example, a small tank that delays the moment of dispensing relative to that of mixing) falls within the scope of post-mix type systems.

Examples of the site or of the delivery of a beverage on a user's premises with a post-mix system include a counter for distribution to the public, a bar, a night club, a restaurant, the self-service counter in a hotel breakfast room, the bar of a discotheque, a private home, a kitchen also of a recreational boat or commercial vessel, and automatic beverage vending machines, as well as any system designed to dispense beverages to the public.

The components of a beverage are to be understood as the basic ingredients which are mixed to obtain the final beverage, irrespective of how each of these basic components/ingredients was previously obtained. In this sense a component, which may have a simple or sophisticated composition, is designed or prepared so as to provide the desired beverage upon the completion of mixing. These components are generally, but not necessarily, in liquid form. Examples of components are carbonated water (to be carbonated on site or already available in carbonated form), still water and syrup. Typically, the syrup is specifically prepared so as to obtain, with the addition of water in the right proportions, beverages such as orangeade, cola, fruit-based juices and any other alcoholic or non-alcoholic beverage, also of a well-known brand in the beverage industry, etc. Although embodiments with two beverage components are described below for the sake of simplicity, the present invention should not be construed as limited to two components only, and the inventive concept illustrated below can be easily extended to three or more components.

“Syrup” can be understood to mean a single component, or multiple components, for example two or more separate syrups or ingredients that are supplied as a component to be mixed with another component using the post-mix type system in question.

In FIG. 1, reference is made to two components of the beverage indicated as 10 and 20, though the invention is not limited to two components. They arrive at the mixing system through, for example, conduits or tubes suitable for conveying liquids such as from the lines 10 (first component) and 20 (second component).

The post-mix type device of the present invention comprises a flow measuring means 100 configured to produce measurement information relating to the flow of the first component.

A flow measuring means is to be understood as a means enabling the flow of a component to be known or measured directly or indirectly. Flow may be understood as the mass of a component conveyed per unit of time, or the volume of a component conveyed per unit of time. For example, the flow measuring means measures the volumetric flow (hereinafter: flow) of one component of the beverage through a tube that transports it. An example of a flow measuring means can be a sensor, a flow meter, etc. The flow measurement can either be averaged over a given period of time or instantaneous. The flow measuring system is capable of outputting an electric signal (analogue or digital) 32 which corresponds (for example is proportional) to the measured flow of the component. The measurement information is represented, in one example, by the analogue or digital signal read by the measuring means, or a processing of this signal. The flow measuring means can be of the turbine type or another type. If a turbine-type flow measuring means is used, it can optionally be equipped with a Hall effect sensor.

The post-mix type device of the present embodiment further comprises a flow rate adjustment means 250 configured to vary the flow rate of the second component. A flow rate adjustment means is to be understood as a means capable of reducing the flow rate of a liquid flowing through a tube. Flow rate may be understood as the mass of a component conveyed per unit of time, or the volume of a component conveyed per unit of time (also including an average volume conveyed in a certain interval of time). The flow rate adjustment means 250 acts on the basis of an electric signal 30 (analogue or digital) which contains and conveys the information necessary for reducing, as necessary, the flow of liquid of the second component 20 that passes through it.

Examples of a flow rate adjustment means are a valve, which may be electrically or electronically actuated, an electronic compensator, etc. The compensator can be motorised, of the compensator cone type with an electrical actuator. The electrical actuator can comprise an electrically controlled stepper motor. In the example, the electrical signal is such as to control the compensator or directly the stepper motor in order to actuate the desired adjustment. Another example of an adjustment means is represented by a solenoid valve, which can be for example closed on command by the control means when a given volume of the component has passed through in a certain interval of time (for example in a certain predetermined period of time or one corresponding to that of dispensing a beverage or a portion thereof).

The control means 300 is configured to receive the measurement information 32 and to control the flow rate adjustment means 250 on the basis of the measurement information and a predetermined parameter. In FIG. 1, the control is actuated, by way of illustration, by means of the signal 30 output by the control means 300 and directed towards the flow rate adjustment means 250. The signal 30 is obtained on the basis of the measurement information and a predetermined parameter. A control means is to be understood as a means, typically electronic, capable of receiving one or more signals, processing them as necessary in relation to a predetermined parameter, which may be memorized inside it or also remotely provided, so as to produce one or more output signals. Examples of a control means are an electronic control unit and an electronic system capable of processing information, possibly containing a microprocessor. The control means can optionally receive further instructions from the user by means of buttons or other input devices, such as, for example, a request for a beverage or a combination of beverages. Moreover, it can also emit signals, for example to the user.

The predetermined parameter is a value or set of values that make it possible to influence the ratio between the quantities or flows of the two components to be mixed. For example, the parameter can be the desired ratio between the flows of the two components or between the volumetric flows of the two components, or the volumetric ratio (instantaneous, averaged over a certain time or total with respect to a single dispensing operation) between the components in the final beverage at the end of dispensing. Moreover, the predetermined parameter can be obtained on the basis of characteristics relating to at least one of the two components; for example, besides depending on the desired ratio, it can be a function of parameters such as the temperature of one or both components, the type of syrup used, etc. The preselected ratio can be a volumetric one, but also any other ratio that can define the final characteristics of the beverage and which it is desirable to control. The parameter can also be a constant, or else a value that depends in turn on different variables (also measured), such as, for example, temperature, mains water pressure, environmental variables or other variables that can affect the final ratio between syrup and water. The parameter can be corrected if necessary on the basis of information provided by the user or on the basis of environmental variables detected by the system.

The parameter is predetermined, i.e. it is already established when the adjustment is or is about to be made. Furthermore, it can be modified, updated or adjusted manually or automatically, locally or from a remote location.

The mixing means 400 is disposed downstream (relative to the direction in which the components flow) of the adjustment means and is configured to mix the first 12 and second 22 components. The mixing means can thus comprise any device that is suitable for mixing the components. In one example, the mixing means 400 can coincide with a beverage dispensing tap in which the two conduits 12 and 22 converge in an outlet conduit of the tap (not illustrated), or else it may be separated in two different devices, from each of which the respective component flows towards a container for the beverage. The mixing means can dispense the duly mixed beverage towards the outside, that is to say, outside the conduits of the device. In fact, the mixing means can optionally also comprise a part serving as an outlet for the beverage, or convey the mixture obtained towards another means serving to dispense the mixture. The beverage can then be collected in a glass, pitcher or bottle or another receptacle so as to be served to the user, or stored in another container belonging to the device so as to be consumed later.

With reference to FIG. 1, the first component 10 of the beverage passes through the flow measuring means 100, which provide the signal 32 to the control means 300. The second component, whose flow rate is regulated by the control means 250, is directed through the conduit 22 towards the mixing means 400. The first component 10 also reaches the mixing means 400 through the conduit 12, after the operation of the flow measurement means 100.

It should be observed that the first and second components are interchangeable, in the sense that the measuring means can be applied on the second component (or branch or conduit of the device) and the adjustment means on the first component (or branch or conduit of the device). For the purposes of this embodiment, it is sufficient that the adjustment and measuring means are each placed in two distinct conduits, that is, in the position of two different components. Thanks to this configuration, in fact, based on the knowledge of the flow present in one component/conduit, the control means will be able to control the adjustment means in the other conduit so as to obtain a certain flow rate in that component. The certain flow rate will also be determined on the basis of the predetermined parameter so that, for example, the adjusted flow is in a desired or pre-established proportion relative to the flow measured in the other branch. In this manner, it is possible to ensure, by controlling the flow rate in one branch, that the flows to be mixed are always according to pre-established controllable proportions and that therefore the dispensed beverage always has the desired qualities. The parameter can be predetermined in view of the ratio between the flows to be mixed, or the ratio between the volumes to be mixed, etc. In one illustrative example, it is supposed that the optimal beverage is obtained from a 1:3 volumetric ratio between two components and that the measuring means measures a flow of 0.91 of a first component. According to this example, the control means will adjust the flow rate of the other component to a value of 2.71/m so as to maintain the 1:3 ratio. The adjustment means can take into account possible compensation factors, and thus apply for example a control of 2.81/m (instead of 2.71/m); the difference of 0.11/m, determinable for example by means of measurements and/or calculations, is such as to ensure in any case the 1:3 ratio in view of the necessary compensations. The parameter can also be made dependent on other values such as ambient temperature, the temperature of one or both components, the sugar content of one component (measured, entered remotely or by an operator, preconfigured but modifiable as needed), etc.

This embodiment of the invention enables the components of the beverage to be dosed with precision by means of a simple control system, thanks to the measurement of the flow of one component and the adjustment of the flow rate of the other component on the basis of the measured flow. Therefore, it is for example possible, once a ratio between water and syrup has been defined, to maintain this ratio constant over time during the dispensing of a beverage, notwithstanding variations in the pushing pressure or density or characteristics of the syrup and also to be able to vary the beverage flow rate. As illustrated further below, one example of the embodiment can be obtained using a turbine flow meter as an example of the measuring means and a cone-type compensator with an electrically controlled actuator as an example of the adjustment means. In such a case, the compensator is controlled by the control means so as to open, close or remain in an unchanged position in order to obtain a given ratio between the components to be mixed. This control proves to be accurate, smooth and without any significant turbulence in the mixing. Another illustrative implementation can be obtained taking a controlled solenoid valve as an example of the adjustment means, or replacing the aforementioned cone-type compensator with a solenoid valve. In such a case, the solenoid valve will be controlled so as to close/open in order to maintain the two components to be mixed in a desired ratio. For example, the solenoid valve can be closed after a certain interval of time in which a quantity (for example a constant flow) of the first component has passed through and when that quantity is such as to satisfy a desired ratio with the quantity of the other component passing through in the same time interval (the quantity of the other component can be determined on the basis of the measurement made by the flow meter on the second component). The solenoid valve can be actuated several times during the control for the purpose of dispensing a beverage or a portion thereof.

Other embodiments will be described below; unless otherwise specified, all the considerations previously set forth will apply. Unchanged components maintain the same reference indications.

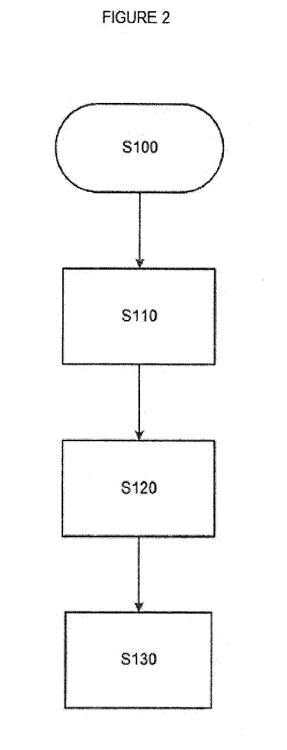

With reference to FIG. 2, a second embodiment aimed at a method for dispensing a beverage and for post-mix type mixing of at least a first component and a second component of the beverage will now be described. The optional step S100 indicates that the method is ready to be started (for example, that a device operating according to the method is ready to be actuated). In step S110, measurement information relating to the flow of the first component is produced. For example, this step can be carried out by the flow measuring means so as to generate information on the flow of one component to be sent to the control means 300. In step S120, the flow rate of the second component is varied (for example, by the flow rate adjustment means 250) on the basis of the measurement information and a predetermined parameter. In step S130, the first component and the second component are mixed (for example by the mixing means 400).

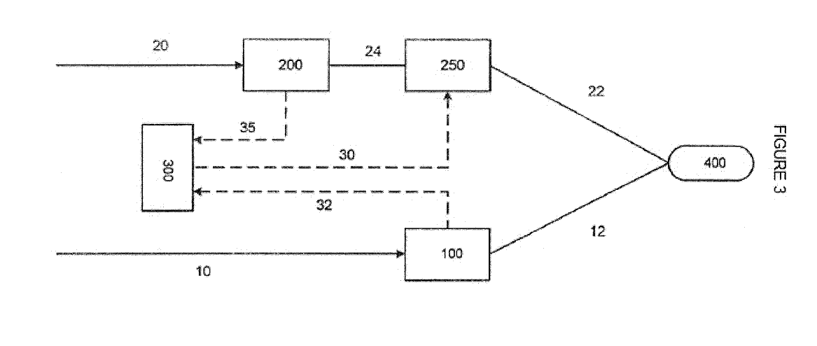

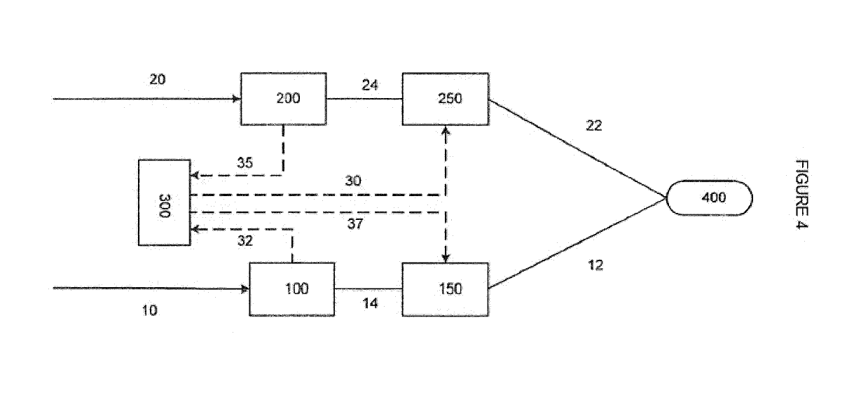

The method of FIG. 2 can comprise further optional steps, according to variants thereof. For example, a step of producing measurement information relating to the flow of the second component as well (in this regard, see also what is explained below with reference to the device of FIG. 3). According to another example, the method can comprise a step of varying the flow rate of the first component as well; reference should also be made to the description given below with reference to FIG. 4.

With reference to FIG. 3, a third embodiment of the invention will now be described; it represents a variant of the first form, since it envisages obtaining flow measurement information about both components. Therefore, only the differences will be described below. In particular, the flow measuring means is further configured to produce measurement information relating to the flow of the second component as well. FIG. 3 illustrates distinct measuring means 100 and 200 (but this is not indispensable) provided in the first and second components, i.e. in the respective conduits. The figure illustrates two outputs 32 and 35 produced by the measuring means; however, the control unit can equally receive only one item of information relating to both measurements, for example when one of the devices 100, 250 picks up the measurement produced by the and sends it together with its own to the means 300. The operation of the device in FIG. 3 is illustrated below. The flow associated with the first component 10 is measured by the flow measuring means 100 and the measurement information 32 is directed to the control means 300. The flow corresponding to the second component 20 is measured by the flow measuring means 200 and the measurement information 35 is provided to the control means 300. On the basis of the measurement information 32 and 35 and a predetermined parameter, the control means 300 sends a signal 30 to the flow rate adjustment means 250 so that said flow rate adjustment means can appropriately adjust the flow rate of the second component to ensure that the predetermined parameter is complied with. The second component 20, adjusted in its flow rate, reaches the mixing means 400 through the conduit 22.

The flow measuring means 200 can be located either downstream or upstream of the flow rate adjustment means 250. The flow measurement, as it regards a flow of liquids (incompressible, at least within certain temperature and pressure intervals), does not generally depend on the position of the measuring device along the line, irrespective of whether or not it comprises a means for measuring the flow rate. However, in particular cases, for example in the presence of a gas (such as carbon dioxide) in either the liquid phase or gaseous phase in a liquid, it could prove convenient to prefer a particular position of the flow measuring means relative to the flow rate adjustment means. This configuration can be obtained by exchanging the position of the blocks 200 and 250 in FIG. 3. Thanks to this configuration, it is possible to obtain a more accurate control. According to an example of this embodiment, the first component is a component to be diluted (for example a syrup), and the second component a diluent (water, carbonated or non-carbonated); the system will nonetheless also work if the two components are swapped over. Based on laboratory tests, however, it appears that if the diluent is carbonated water, a more accurate control is obtained when the first component is the one to be diluted (i.e. the component to be diluted is the component whose adjustment is controlled via the means 250) than in the case in which the control is performed only on the water side (although in this case as well a generally more accurate control is obtained). The reason lies in the fact that if only the carbonated water is adjusted, during the adjustment thereof air bubbles could be generated and propagated inside the tubing, which would lead to an inexact measurement of the flow in the water conduit and hence a less accurate control.

With reference to FIG. 4, a fourth embodiment of the invention will now be described with reference to the differences compared to the previously introduced embodiments, of which it represents a variant. The device of FIG. 4 comprises flow rate adjustment means (150, 250) which is further configured to vary the flow rate of the first component as well. In the figure, said means is schematically illustrated as two distinct blocks, but that is not necessary for the construction thereof. The difference compared to the other embodiments lies in the fact that both the flow measurement and flow rate adjustment are performed for both components. The control means can thus operate on both adjustments, or on the one which it is more effective to control at a certain moment according to the control algorithm used, based on the flow measurements of both components. One method of operation of the device of FIG. 4 is illustrated below. The flow of the first component 10 is measured by the flow measuring means 100, which sends the control means 300 measurement information 32 corresponding to the flow of the first component. The flow of the second component 20 is measured by the flow measuring means 200, which send information about the measurement made to the control means. On the basis of the measurement information 32 and 35 and a predetermined parameter, the control means 300 sends specific signals 37 and 30 to the flow rate adjustment means 150 and 250, respectively, so that said flow rate adjustment means can adjust the flow rate of the first and second components independently in such a way that the predetermined parameter is complied with. The first component 10 and the second component 20, adjusted in their flow, reach the mixing means 400 through the conduits 12 and 22, respectively.

As noted above, the relative positions of the flow measuring means and flow rate adjustment means can be swapped. In other words, the positions of the blocks 200 and 250 can be swapped over, as can the positions of the blocks 100 and 150 independently of the exchange of the positions of the blocks 200 and 250. Thanks to such a device, it is thus possible to control the quality of the final beverage in a simple but very accurate manner. Furthermore, the adjustment can be obtained rapidly and thus also for small amounts of beverage to be dispensed.

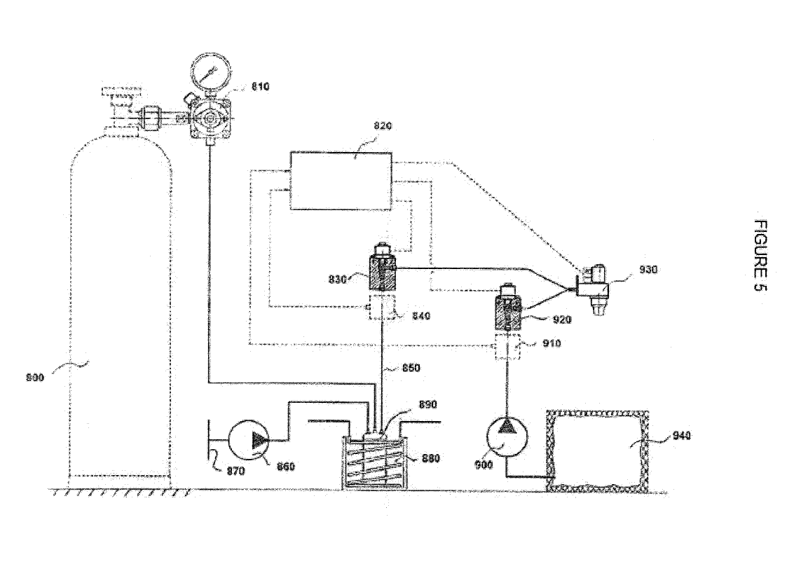

With reference to FIG. 5, a fifth embodiment of the invention will now be described. The figure shows how the beverage components arrive at the post-mix dispensing tap 930 (an example of the mixing means described above). A first component, represented by a syrup, is contained in a bag-in-box 940 and is pushed by a pump 900 towards the flow measuring means 910 and the flow rate adjustment means, for example an electronic compensator 920, so as to then flow into the tap 930. A second component, in the example water coming from the mains supply 870, is pushed by a pump 860 into the carbonator 890 and cooled in the tank 880. Carbon dioxide contained in the cylinder 800 also flows into the carbonator through the pressure reducer 810. The water to which carbon dioxide has been added is thus chilled; then, pushed by the pressure of the pump 860, it passes through the flow measuring means 840 and flow rate adjustment means or electronic compensator 830 via the conduit 850, finally reaching the post-mix dispensing tap 930. The signals coming from the flow measuring means 910 and 840 are sent to the control means 820, which, on the basis of these signals and a predetermined parameter outputs a signal directed at the flow rate adjustment means 920 and 830, which adjust the flow rate of the chilled carbonated water and of the syrup based on the actual volumetric flow of water and syrup measured by the flow measuring means 910 and 840. The figure illustrates components that are not strictly necessary, such as the pumps (not necessary if the pressure of the mains water supply is sufficient, or if the water and syrup tanks are positioned above or placed under pressure), the chilling means, the reducer 810, etc.

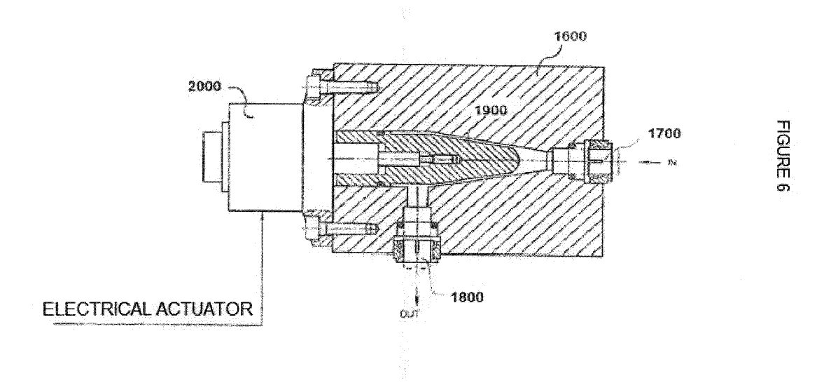

With reference to FIG. 6, a compensator which represents an example of the previously described flow rate adjustment means will now be described. The compensator cone 1900 can be moved in a horizontal direction (i.e. along the direction of the arrow IN) by the actuator 2000. When the cone is in the closed position, that is to say, at the maximum of its rightward travel in the figure, i.e. toward the inlet 1700, the liquid entering through the inlet 1700 cannot flow because the cone blocks its passage by completely closing off the orifice against the block 1600. On the other hand, when the cone 1900 is completely or partially moved leftward (i.e. toward the actuator 2000), the orifice is opened and the liquid can flow, finding the outlet 1800 (OUT), The actuator 2000 can be of a mechanical, electrical or electronic type. The actuation can be provided by means of an electric motor, for example of the electronically controlled stepper type. The signals of the control means 300 will therefore adjust the rotation of the motor and as a consequence the opening of the orifice towards the outside and thus the flow rate of the component. This enables a very accurate, smooth, non-turbulent control of mixing. The compensator is not however limited to a wedge shape. For example, it can have a truncated pyramid shape. In fact, other compensators can also be used, as long as they have two surfaces that are movable relative to each other and the relative movement (for example translational and/or rotational) is such as to vary the orifice or the space interposed between the two surface between a position of closure of the orifice and a position of maximum opening so as to allow a variation in the flow or in the quantity of liquid and/or gas that pass through it (i.e. through the orifice). The relative movement can be continuous (for example via an appropriately controlled electric motor) or in steps (stepper motor). As is evident from the figure, it may be noted that the flow of liquid is such that whilst it exits in an inclined direction (perpendicular in the figure) relative to the rotation axis (coinciding with the axis of the cone), it enters in an axial direction so that the fluid moves in an axial direction before exiting through the outlet 1800. This movement of the fluid contributes to decreasing the turbulence thereof. It is also evident to the person skilled in the art that the inlet and outlet can be swapped.

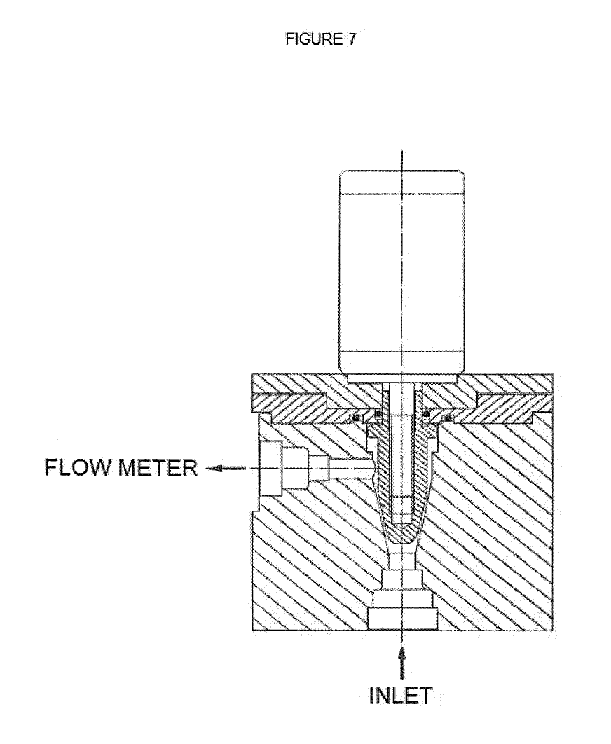

With reference to FIG. 7, another flow rate adjustment means, similar to the one illustrated in FIG. 6, will now be described. It may be noted that the liquid coming from the entrance INLET can be blocked by the cone that obstructs its passage, or allowed to flow towards the outlet. In the case of the flow rate adjustment means illustrated, the outgoing liquid is directed towards a flow meter, which represents an example of the flow measuring means (100, 200, 840, 910).

As mentioned, a solenoid valve represents another example of an adjustment means that is equally applicable to the invention and the embodiments thereof. For example, in FIG. 3, the solenoid valve can be opened or closed in such a way as to maintain the two components to be mixed within a given volumetric or flow ratio. The closing or opening of the solenoid valve can be repeatedly controlled over the time in which it is desired to perform the adjustment. Analogously, in FIGS. 4, 5, 8 and 9 the adjustment means can be represented by solenoid valves. It should be noted that the adjustment means (for example in FIGS. 4 and 5) can be formed by a combination of a solenoid valve to be applied on one component, and a turbine for the other component, i.e. the adjustment means can be implemented differently on the branches of the two components.

According to another embodiment, there is provided a computer program comprising instructions suitable for executing, when the program is run on a computer, the steps of the method illustrated in FIG. 2 or variants thereof. It is moreover possible to create a program, to be run on a single microprocessor or distributed over a number of processors (also remote ones), in such a way as to manage the operation of the devices of the previous embodiments. For example, the computer program enables the control system 300 to perform calculations on the basis of the information received, in particular information on the measurements performed, and to emit control signals aimed at the flow rate adjustment means to ensure that the (flow, volumetric etc.) ratio between the first and the second components corresponds to the one desired.

The computer program can execute further instructions, such, for example, instructions to carry out a flushing step on the beverage outlet tap which consists in dispensing only water, or to dispense a single component or a particular combination of components. Other instructions executed by the program can enable calibration, check and/or setting procedures, just as special instructions for mixing special versions of a beverage can be provided. Moreover, the computer program can generate warnings and alarms regarding the lack of syrup, the mains water supply pressure, pressure in the syrup transfer line or other alarms. The computer program can be run on a computer, dedicated hardware, a device comprising one or more processors, a distributed calculation system, etc.

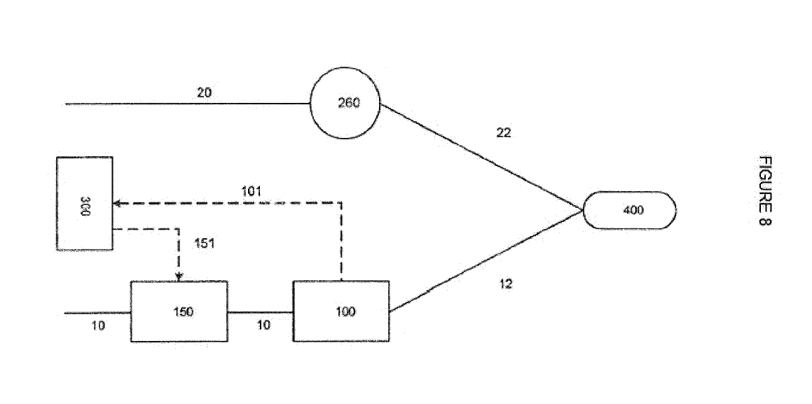

With reference to FIG. 8, a further embodiment of the invention will now be described. In fact, it is not generally necessary for the flow measuring means and flow rate adjustment means to act on two different beverage components, i.e. on the two different conduits 10 and 20 of FIG. 1. They can in fact act upon the same beverage component, for example on the first component 10, when the flow of the other component is already known, at least with sufficient precision, i.e. within a certain acceptable tolerance depending on the cases. Therefore, assuming the flow of the second component 20 of the beverage to be known, it will be sufficient to measure the flow of the first component 10 via the flow measuring means 100 and adjust the flow rate of the latter via the flow rate adjustment means 150 in order to comply with the predetermined parameter. The main differences compared to the device of FIG. 1 will thus be illustrated below.

The pushing means 260 is a means capable of producing the forward movement of a liquid along a tube or conduit. The pushing means can be, for example, a pump or another device capable of creating pressure on the liquid column it is applied on in such a way as to push the liquid in one direction, or, alternatively, the forward movement of the liquid can be induced by negative pressure downstream.

It should be noted that in the present example the flow rate adjustment means 150 is located downstream of the flow measuring means 100. As already mentioned previously, in fact, the order in which these means are installed along a same line is neither essential nor generally important for the purposes of the operation of the present invention.

One example of how the flow of one component can be considered to be known with sufficient precision is that in which a pump 260 of the peristaltic type is used to push the component. This type of pump has the characteristic of pushing a constant or nearly constant quantity (volume) of liquid per unit of time, so that this flow can be considered known with excellent or at any rate acceptable approximation. Other types of pumps can however be used to push a component while being able to consider the flow to be known and/or largely independent of other parameters. In this case as well, it is possible to obtain a beverage with easily controllable characteristics.

The present invention also relates to the mixture obtained through one of the methods illustrated above, or through the operation of one of the devices illustrated above, or by running a computer program operating according to the invention.

A mixture of at least a first component and a second component produced according to one of the embodiments described is characterized in that it is possible to control the ratio between the components with precision. The precision is given by the above-described system, which makes the proportions of the components making up the mixture largely independent of the conditions outside the system (temperature, mains water supply pressure, viscosity of the syrup, etc.), thanks to the control means, which is capable of controlling one or more flow rate adjustment means, correcting any disproportions.

The various embodiments have been described with reference to the mixing of two components, but the invention is not limited to this case. In fact, other components can be mixed together with the first two to form a beverage. The other components can be mixed without any control being applied to them; or else the flow rate of one or more of the other components can be adjusted on the basis of the measured flow of one of the first two components (see FIG. 1), or on the basis of the generated flow of both of the first components (FIG. 3). Moreover, it is possible to envisage a device in which the flow of each component is measured and the flow rate of each component is adjusted accordingly (i.e. the concept of FIG. 4 can be extended to an arbitrary number of components).

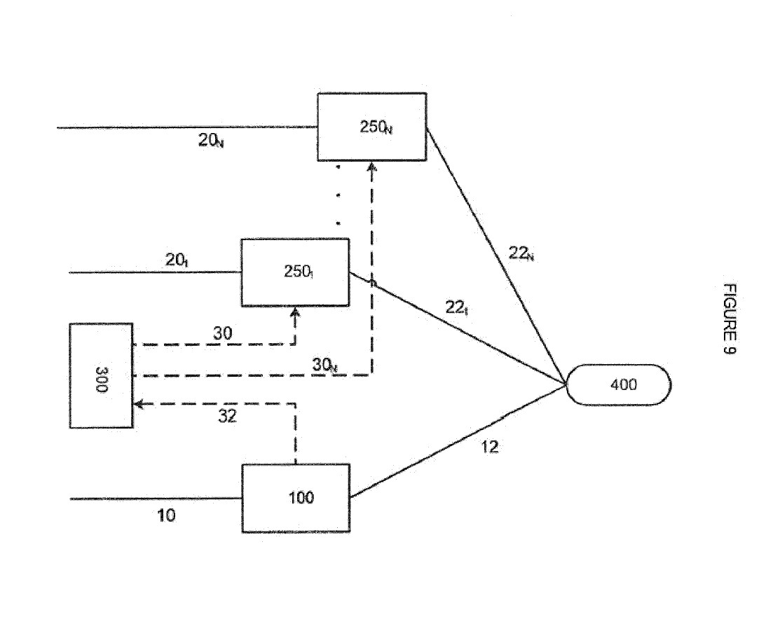

Furthermore, a post-mix type system for obtaining a number of beverages can be obtained. For example, a post-mix type device can be used to obtain N beverages by creating inside it N sub-devices (with N=1, 2, etc.) as per FIG. 1, 3, 4, 5 or 8. It is further possible to obtain a multi-beverage device of the post-mix type by modifying the one in the aforementioned figures. For example, FIG. 9 represents a modification of FIG. 1 in which N second components (N=1, 2, etc.) are present. Each of the N second components comprises for example a syrup of the desired beverage, which will be mixed with the first component 10 in common with all the beverages. In the example, the control means will actuate the adjustment of the component (i=1, 2, . . . , N) corresponding to the selected beverage.

The mixing means, like the adjustment means, can be shared or separate for each of the beverages. When shared, an operation of flushing the mixing and/or dispensing means can be carried out. Similarly, FIGS. 3, 4, 5 and 8 can be modified by adding further second components and respective means to enable a second component i (i=1, 2, . . . , ) to be mixed with the first component in common with each of the second components. In the above description, an illustration was given of a device that can be constructed as an independent unit or included in an apparatus comprising additional units. Furthermore, in the above description, it is possible to replace the above-described measuring means with a flow meter (or number of flow meters) and equivalents thereof. Similarly, the adjustment means can be replaced by a compensator (or number of compensators) and equivalents thereof; the control means by a processor and equivalents thereof; the mixing means by a mixer and equivalents thereof; and the dispensing means by a tap and equivalents thereof.

Naturally, the above description of embodiments and examples applying the principles recognized by the inventors is given solely by way of illustration of such principles and must therefore not be construed as limiting the scope of the invention claimed here.

1. A post-mix type device for dispensing beverages at a user and mixing at least a first component (10) and a second component (20), said device comprising:
a flow measuring means (100) configured to produce measurement information relating to the flow of the first component;
a flow rate adjustment means (250) configured to vary the flow rate of the second component;
a control means (300) configured to receive the measurement information (32) and to control the flow rate adjustment means (250) on the basis of the measurement information and a predetermined parameter;
a mixing means (400) disposed downstream of the flow rate adjustment means and configured to mix the first (12) and second (22) components.

2. The device according to claim 1, wherein the flow measuring means (100, 200) is further configured to produce measurement information (32, 35) also relating to the flow of the second component.

3. The device according to claim 1 or 2, wherein the flow rate adjustment means (150, 250) is further configured to vary the flow rate of the first component as well.

4. The device according to any one of claims 1 to 3, wherein the predetermined parameter corresponds to a desired ratio between the flows of the two components.

5. The device according to any one of claims 1 to 4, wherein the predetermined parameter is obtained on the basis of the characteristics associated with at least one of the two components.

6. The device according to any one of claims 1 to 5, further comprising a means (400) for dispensing a mixture of the two components (12, 22) towards the outside.

7. The device according to any one of claims 1 to 6, wherein the flow measuring means (100, 200) comprises either a turbine type flow meter or a turbine type flow meter provided with a Hall effect sensor.

8. The device according to any one of claims 1 to 7, wherein the flow rate adjustment means (150, 250) comprises a cone-type motorized compensator with an electrical actuator.

9. The device according to claim 8, wherein the electrical actuator of the cone of the motorized compensator comprises an electronically controlled stepper motor.

10. A method for dispensing beverages on a user's premises and post-mix type mixing of at least a first component and a second component, the method comprising the steps of:
producing measurement information (S110) relating to the flow of the first component;
varying the flow rate of the second component (S120) on the basis of the measurement information and a predetermined parameter;
mixing the first and second components (S130).

11. The method according to claim 10, further comprising the step of producing measurement information relating also to the flow of the second component.

12. The method according to either of claims 10 and 11, further comprising the step of varying the flow rate also of the first component.

13. A mixture composed of at least a first component and a second component, wherein the mixture is produced according to the method of one of claims 10 to 12.

14. A computer program comprising instructions suitable for executing, when the program is run on a computer, the steps of each of claims 10 to 12.

15. A post-mix type device for dispensing beverages at a user and mixing at least a first component (10) and a second component (20), said device comprising:
a flow measuring means (100) configured to produce measurement information relating to the flow of the first component;
a flow rate adjustment means (150) configured to vary the flow rate of the first component;
a pushing means (260) configured to generate a known flow of the second component;
a control means (300) configured to receive the measurement information (101) and to control the flow rate adjustment means (150) on the basis of the measurement information and a predetermined parameter;
a mixing means (400) disposed downstream of the flow rate adjustment means and configured to mix the first (12) and second (22) components.
